(19) United States
(12) Patent Application Publication
(10) Pub. No.: US 2026/0159748 A1
(43) Pub. Date: Jun. 11, 2026

(54) GEOPOLYMER COMPOSITIONS, AND RELATED GEOPOLYMER SLURRIES AND METHODS

(71) Applicant: Schlumberger Technology Corporation, Sugar Land, TX (US)

(72) Inventors: Carlos Abad, Houston, TX (US); Sandra Janette Montoya Padilla, Cota (CO); Bernardo Engelke, Sugar Land, TX (US); Miguel Molano, Cota (CO)

(21) Appl. No.: 19/181,101

(22) Filed: Apr. 16, 2025

Related U.S. Application Data
(60) Provisional application No. 63/634,545, filed on Apr. 16, 2024.

(51) Int. Cl. C09K 8/467; C04B 14/36; C04B 28/00; C04B 103/00; E21B 33/14

(52) U.S. Cl. CPC C09K 8/467; C04B 14/36; C04B 28/006; E21B 33/14; C04B 2103/008

(57) ABSTRACT

A geopolymer composition for a subterranean wellbore includes at least aluminosilicate source and at least one material including one or more of an aluminum source, a sulfate source, or an organic coagulant. The at least one material may include an aluminum sulfate salt. Related geopolymer slurries formed from the geopolymer composition and related methods are also disclosed.

### CROSS-REFERENCE TO RELATED APPLICATIONS

This application claims the benefit of, and priority to, U.S. Patent Application No. 63/634,545, filed Apr. 16, 2024, which application is incorporated herein by this reference in their entireties.

### BACKGROUND OF THE DISCLOSURE

Wellbore drilling operations includes drilling a bore in a formation to access reservoirs of hydrocarbons and other subsurface resources. After a drilling operation, a casing string may be run through the wellbore and cemented into place. The cement may facilitate isolating a section of the formation from other portions of the formation. Cementing may be performed in a single-stage where the cement is pumped into the casing, down a cement shoe, and then up into an annulus between the casing and the formation. In other cases, such as where the casing string is long or the formation cannot support the hydrostatic pressure of a column of the cement, the cementing may be performed in a multi-stage operation. For example, the wellbore may include a conductor casing proximate the surface, a surface casing extending beyond (e.g., below) the conductor casing, an intermediate casing beyond the surface casing, and a production line beyond the intermediate casing. Cement may be located between the formation and each of the casings and the formation, as well as between the neighboring casing sections. It is desired for the resulting cement to exhibit a compressive strength (hereinafter “CS”) able to withstand formation pressures.

Geopolymers are a class of amorphous materials that are formed by chemical reaction of (e.g., chemical dissolution and subsequent recondensation) of various aluminosilicate oxides and silicates to form an amorphous three-dimensional framework structure. Geopolymers have been investigated for use in several applications, including as concrete systems within the construction industry, as refractory materials, and as encapsulants for hazardous and radioactive waste streams. Geopolymers are also recognized as being rapid setting and hardening materials. The preparation of geopolymers generally involves mixing a blend of reactive solid materials and activating the polymerization reaction by adding an alkaline solution. The slurry mixture may then be applied and allowed to harden in place. Geopolymers have been investigated as alternatives for wellbore cement.

Geopolymers based on alumino-silicates are designated as poly(sialate), which is an abbreviation for poly(silicon-oxo-aluminate) or (—Si—O—Al—O)ₙ or (—Si—O—Al—O—Si—O)ₙ, wherein n corresponds to the degree of polymerization of the geopolymer. Such geopolymers include silicon atoms and aluminum atoms that are bridged with one another via oxygen atoms. The sialate network comprises SiO₄ and AlO₄ tetrahedra linked alternately by sharing all the oxygen atoms, with Al³⁺ and Si⁴⁺ in IV-fold coordination with oxygen. Positive ions (Na⁺, K⁺, Li⁺, Ca²⁺) may be present in the framework cavities to balance the negative charge of Al³⁺ in IV-fold coordination. The empirical formula of polysialates is Mₙ[—(SiO₂)_{z}—AlO₂]ₙ, where M is a cation such as potassium, sodium, or calcium, n is a degree of polymerization, and z is the silicon to aluminum ratio (the Si/Al ratio).

In the hydrocarbon industry, cement-like materials are used to line wellbores to provide isolation and structural support within the wellbore. Use of cement-like materials in hydrocarbon wellbores presents unique challenges. The slurry mixture precursor is typically pumped over long distances to the location where the mixture is to set, so the mixture must be pumpable without undue burden on equipment. Additionally, ambient conditions encountered in a typical hydrocarbon well are much more extreme than those encountered in a typical construction application. Further, the large vertical extent of hydrocarbon wellbore applications presents challenges of density, temperature, and pressure not faced in the construction industry.

### SUMMARY

In some embodiments, a geopolymer composition comprises at least one aluminosilicate source, and at least one material comprising one or more of an aluminum source, a sulfate source, or an organic coagulant.

In some embodiments, a geopolymer slurry comprises a geopolymer composition including at least one aluminosilicate source, aluminum cations formed from at least one aluminum salt, and sulfate anions formed from at least one sulfate salt. The geopolymer slurry further includes an aqueous carrier fluid.

In some embodiments, a method of cementing a subterranean borehole comprises mixing water with a geopolymer composition to form a geopolymer slurry into an annular space between a casing and a subterranean formation defining the subterranean borehole. The geopolymer composition comprises at least one aluminosilicate source, at least one of an aluminum salt, a sulfate salt, or an organic coagulant, and at least one activator.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a representation of a drilling system for drilling an earth formation to form a wellbore, according to at least one embodiment of the present disclosure;

FIG. 2 is a simplified, partial cross-sectional view illustrating a portion a downhole system, according to at least one embodiment of the present disclosure; and

FIG. 3 is a simplified flow chart illustrating a method of performing a cementing operation, according to at least one embodiment of the present disclosure.

### DETAILED DESCRIPTION

As used herein, “geopolymer composition” means and includes a mixture (blend) of one or more materials used to which water may be added to form a slurry, referred to herein as a “geopolymer slurry.” During hardening (also referred to as “setting”), the geopolymer slurry undergoes polycondensation wherein the composition included in the slurry (e.g., aluminosilicate) polymerizes and forms a crosslinked network, which may be referred to herein as a “geopolymer,” a “set geopolymer,” or a “hardened geopolymer.”

This disclosure generally relates to devices, systems, and methods for geopolymer compositions, geopolymer slurries, and geopolymers including at least one aluminosilicate material, and at least one material formulated and configured to facilitate agglomeration of particles within the geopolymer slurry formed from the geopolymer composition. The at least one material formulated and configured to facilitate agglomeration of particles within the geopolymer slurry may include one or more of an aluminum source, a sulfate source, or a coagulant, such as an organic coagulant. In some embodiments, the geopolymer composition includes at least one aluminum source (e.g., a source of aluminum ions) and at least one sulfate source (e.g., a source of sulfate ions). The at least one aluminum source and the at least one sulfate source may be formed from and include the same material (e.g., the same salt). By way of non-limiting example, the at least one aluminum source and the at least one sulfate source may include aluminum sulfate (Al₂(SO₄)₃). In some embodiments, the at least one aluminum source includes an aluminum salt and the at least one sulfate source includes a sulfate salt (e.g., different than the aluminum salt).

The geopolymer composition may further include an alkali activator material or an activator precursor material. In addition, the geopolymer composition may include one or more additives, such as one or more of a metal silicate, a retarder, an accelerator, a binder, a density modifier, a viscosifier, a fluid loss agent, an extender, a dispersant, an antifoam agent, a defoamer, silica, an expanding agent, an anti-settling additive, another additive, or combinations thereof. The one or more additives include at least one material selected from the group consisting of at least a metal silicate, a retarder, an accelerator, a binder, a density modifier, a viscosifier, a fluid loss agent, an extender, a dispersant, an antifoam agent, a defoamer, silica, an expanding agent, and an anti-settling additive.

The geopolymer composition, when mixed with an aqueous solution, forms a geopolymer slurry exhibiting a reduced viscosity and improved rheology compared to geopolymer slurries that do not include the at least one aluminum source, the at least one sulfate source, and/or the at least one coagulant (e.g., the organic coagulant). For example, the geopolymer slurry may exhibit fewer fines (e.g., fume particles) compared to geopolymer slurries that do not include the at least one aluminum source, the at least one sulfate source, and/or the at least one coagulant. In addition, the geopolymer slurries may exhibit a hardening time such that the geopolymer slurry hardens at a rate suitable for being pumped downhole. Further, the geopolymer slurry and the resulting geopolymer may exhibit a compressive strength development (“CSD”) and ultimate compressive strength (“CS”) able to withstand formation pressures. The higher rate of CSD may reduce the duration between the cementing operation and one or more additional wellbore operations, such as additional drilling, completion, production, or other operations. The geopolymer slurries including the at least one aluminum source, the at least one sulfate source, and/or the at least one coagulant may set to form a geopolymer exhibiting a reduced degree of expansion after hardening, a higher hardness, and a reduced permeability to fluids compared to geopolymers formed from compositions that do not include the at least one aluminum source, the at least one sulfate source, and/or the coagulant.

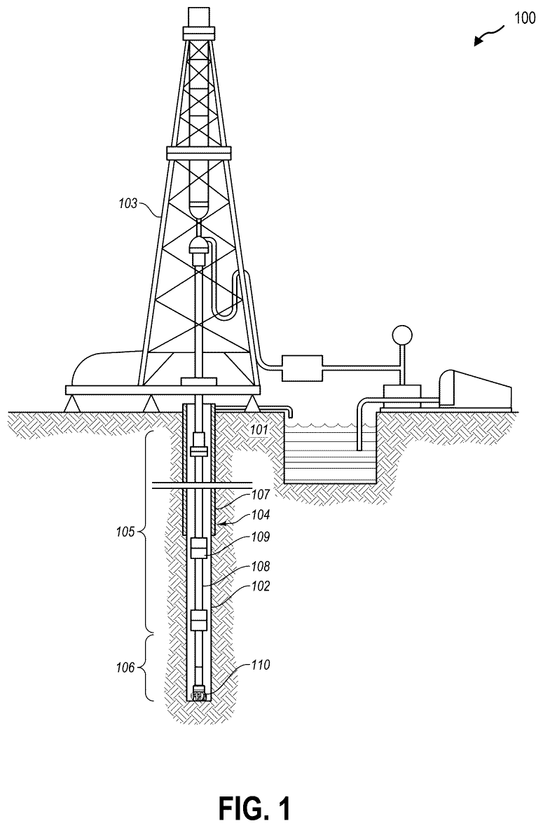

FIG. 1 shows one example of a drilling system 100 for drilling an earth formation 101 to form a wellbore 102 during a drilling operation. The drilling system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

After a section of the wellbore 102 has been drilled, the drill string 105 may be tripped (removed from the wellbore 102) and at least a portion of the earth formation 101 may be lined with a casing 107. After placing the casing 107, a cement operation may be performed during which cement is pumped through the casing 107, through the bottom of the casing 107, and out of the annulus between the casing 107 and the earth formation 101. After the cement sets, additional wellbore operations (e.g., additional drilling, completion) may be performed.

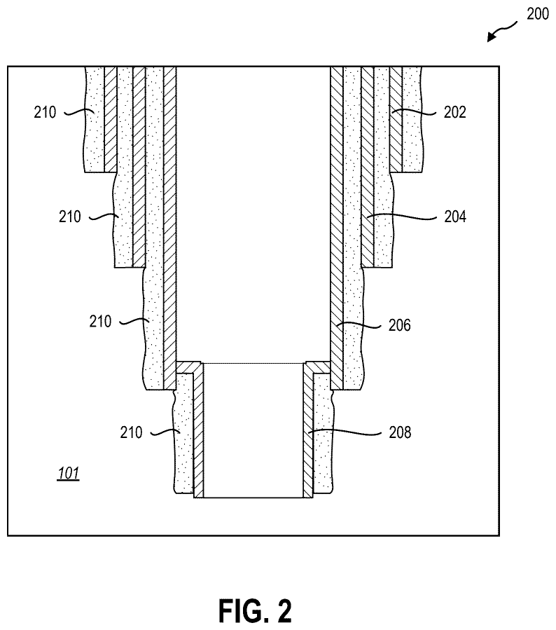

FIG. 2 is a simplified, partial cross-sectional view illustrating a portion of a downhole system 200 including the earth formation 101 after one or more cementing operations have been performed in the wellbore 102 (FIG. 1), in accordance with embodiments of the disclosure. The downhole system 200 may include multiple sections of casing, each extending from the surface (at the drill rig 103 (FIG. 1)) through a portion of the earth formation 101 and progressively extending farther into the earth formation 101. For example, the casing may include a conductor casing 202 extending from the surface through a portion of the earth formation 101, a surface casing 204 extending from the surface beyond the conductor casing 202, an intermediate casing 206 extending beyond the surface casing 204, and a production casing 208 (also referred to as a “production liner”) extending from the surface beyond the intermediate casing 206. The conductor casing 202 may be configured to protect shallow portions of the earth formation 101 from contamination, such as by drilling fluids. The surface casing 204 may facilitate maintaining integrity of the wellbore 102 (FIG. 1) and/or prevent (substantially prevent) contamination of groundwater by hydrocarbons, subterranean brines, and drilling fluids. The intermediate casing 206 may be configured to isolate hydrocarbon-bearing portions of the earth formation 101 and fractured and lost circulation zones. The production casing 208 may be configured to isolate zones of the earth formation 101 above and within a production zone.

The sections of casing may individually be isolated from the earth formation 101 by a geopolymer 210. For example, the geopolymer 210 may be located in the annular space between the earth formation 101 and each of the conductor casing 202, the surface casing 204, the intermediate casing 206, and the production casing 208. In some embodiments, the geopolymer 210 may be located in the annular space between neighboring sections of the casing, such as between the conductor casing 202 and the surface casing 204, between the surface casing 204 and the intermediate casing 206, and between the intermediate casing 206 and the production casing 208.

The geopolymer 210 may exhibit a greater CS and a relatively lower density than conventional cements used during wellbore construction. According to embodiments described herein, the geopolymer 210 may be formed by mixing a geopolymer composition with water or an aqueous solution to form a geopolymer slurry (also referred to as a “slurry composition”). The geopolymer slurry may be pumped through the sections of casing and into the annulus between the individual casing sections and the earth formation 101. The geopolymer slurry may exhibit improved rheology (and improved flowability) compared to geopolymer slurries not including the at least one aluminum source, the at least one sulfate source, and/or the at least one coagulant. In addition, the geopolymer slurry may exhibit a relatively shorter CSD compared to conventional geopolymer slurries, facilitating continuing wellbore operations faster than when using geopolymer slurries exhibiting a relatively longer CSD. Further, the geopolymer may exhibit a reduced permeability to wellbore fluids and formation fluids compared to other geopolymers.

As described herein, due to the presence of at least one aluminum source, the at least one sulfate source, and/or the at least one coagulant in the geopolymer composition from which the geopolymer slurry is formed, the hardened geopolymer may exhibit improved properties compared to other geopolymers. For example, the presence of the at least one aluminum material, the at least one sulfate material, and/or the at least one coagulant in the geopolymer composition may facilitate agglomeration of fines within the geopolymer composition, improving the pumpability of the geopolymer slurry. The geopolymer slurry may exhibit improved CSD and may form the geopolymer 210 to exhibit improved ultimate CS and ductility, reduced microfractures due to hydration (e.g., of calcium oxide or magnesium oxide), and reduced fluid loss of wellbore fluids and fluids from the earth formation 101.

The geopolymer 210 may be formed from a geopolymer slurry including a geopolymer composition mixed with a carrier fluid (e.g., water or an aqueous solution). The geopolymer composition may include a base composition and one or more additives, such as one or more of a metal silicate, a retarder (e.g., sodium lignosulfonate (C₂₀H₂₄Na₂O₁₀S₂)), an accelerator, a binder, a density modifier, a viscosifier (e.g., xanthan gum), a fluid loss agent (e.g., cellulose), an extender (e.g., sodium metasilicate (Na₂SiO₃), perlite), a dispersant (e.g., a sodium polynaphthalene sulfonate-based material), an antifoam agent, a defoamer, silica, an expanding agent, an anti-settling additive, or combinations thereof.

The base composition may include at least one aluminosilicate source and one or more of the aluminum source, the sulfate source, or the coagulant (e.g., an organic coagulant). In some embodiments, the base composition includes at least one aluminum source and at least one sulfate source and does not include the coagulant. In some embodiments, the base composition includes the at least one organic coagulant and does not include the at least one aluminum source or the at least one sulfate source. In other embodiments, the base composition includes each of the at least one aluminum source, the at least one sulfate source, and the at least one organic coagulant. The base composition may further include at least one activator material and/or at least one activator precursor material.

The at least one aluminosilicate source may be in the form of a solid or an aqueous solution of metal silicate. The at least one aluminosilicate source may include, but is not limited to, fly ashes such as ASTM type C fly ash, ASTM type F fly ash, and fly ashes not classified by ASTM, volcanic ash, volcanic glass, slag, ferrous slag, ferroalloy slag, non-ferrous slag (e.g., copper slag, nickel slag, tin slag, zinc slag), blast furnace slag, basic oxygen furnace slag, electric arc furnace slag, ground blast furnace slag (GGBS), diatomaceous earths, pumice, calcined or partially calcined clays (such as metakaolin), aluminum-containing silica fume, natural aluminosilicate, feldspars (which may be dehydrated), alumina and silica sols, synthetic aluminosilicate glass powder, zeolite, scoria, allophone, bentonite, red mud, which may be calcined, and pumice. Such materials may include a significant proportion of an amorphous aluminosilicate phase, which reacts in strong alkaline solutions. In some embodiments, the at least one aluminosilicate source includes at least one of fly ash, metakaolin, or blast furnace slag. Mixtures of two or more aluminosilicate sources may also be used if desired. In addition, alumina and silica sources may be added separately, for example, as a blend of bauxite and silica fume. Other amorphous silica sources can also be used, which may include soda-lime glass dust, borosilicate glass dust, microsilica, fumed silica, precipitated silica, nanosilica, rice husk ash, or a combination thereof. It should be noted that some of the aluminosilicate sources mentioned above, such as GGBS and ASTM Class C fly ash, also contain calcium oxide, so these materials can also be considered activator sources. Suitable aluminosilicate sources for purposes herein can have at least 2%, at least 7%, at least 12%, at least 18%, at least 25%, at least 30%, at least 35%, at least 40%, at least 45%, or at least 50% by weight calcium oxide. These aluminosilicate sources become reactive when placed in strongly alkaline environments, typically at pH greater than 11. The aluminosilicate sources described above react under such conditions to form geopolymers and other materials derived from alkali active materials.

The at least one aluminosilicate source may be present in the geopolymer composition at a weight percent within a range of from about 50 weight percent to about 99 weight percent, such as from about 50 weight percent to about 60 weight percent, from about 60 weight percent to about 70 weight percent, from about 70 weight percent to about 80 weight percent, from about 80 weight percent to about 90 weight percent, from about 90 weight percent to about 95 weight percent, from about 95 weight percent to about 97 weight percent, or from about 97 weight percent to about 99 weight percent, based on the weight of the blend (BWOB), wherein the weight of the blend includes the weight of the geopolymer composition (including the aluminosilicate source and other materials in the geopolymer composition). However, the disclosure is not so limited, and the weight percent of the at least one aluminosilicate source in the geopolymer composition may be different than that described.

The at least one aluminum source may include at least one aluminum salt. The at least one aluminum salt, when dispersed in the carrier fluid and in the geopolymer slurry, may dissociate and form aluminum cations and counterions including the anion of the at least one aluminum salt. For example, in some embodiments, the at least one aluminum source includes aluminum sulfate (Al₂(SO₄)₃), and the aluminum sulfate provides aluminum cations and sulfate anions in the geopolymer slurry.

The at least one aluminum source may include one or more of aluminum sulfate, aluminum chlorohydrate (AlₙCl₍₃ₙ₋ₘ₎(OH)ₘ, such as Al₂Cl(OH)₅), poly aluminum chloride (PAC) (also referred to as “aluminum chloride hydroxide”) (Al₂(OH)ₙCl₍₆₋ₙ₎)ₘ, wherein n is between 1 and 5 and m is less than 10), calcium aluminate (e.g., tricalcium aluminate (3 CaO·Al₂O₃), monocalcium aluminate (CaO·Al₂O₃), dodecacalcium hepta-aluminate (12 CaO·7Al₂O₃), monocalcium dealuminate (CaO·2Al₂O₃), monocalcium hexa-aluminate (CaO·6Al₂O₃), dicalcium aluminate (2CaO·Al₂O₃), pentacalcium trialuminate (5CaO·3Al₂O₃), tetracalcium trialuminate (4CaO·3Al₂O₃)), aluminum phosphate (Al(PO₄)), aluminum trichloride (AlCl₃), aluminum containing industrial waste, red mud, aluminum nitrate (Al(NO₃)₃, aluminum carbonate (Al₂(CO₃)₃), aluminum hydrogen carbonate (Al(HCO₃)₃), aluminum phosphate (AlPO₄), aluminum hydrogen phosphate (Al(H₂PO₄)₃), aluminum dihydrogen phosphate (Al(H₂PO₄)₃), aluminum borate (AlBO₃), aluminum trifluoride (AlF₃), or combinations thereof.

The at least one aluminum source may be formulated and configured to form hydroxy aluminate when dispersed in a geopolymer slurry including the geopolymer composition and the carrier fluid. In some embodiments, the at least one aluminum source includes aluminum sulfate. The aluminum sulfate may be present in one or more aluminum sulfate-containing materials, such as one or more of millosevichite, aluminum sulfate hydrates (e.g., aluminum sulfate hexadecahydrate (Al₂(SO₄)₃·16H₂O), aluminum sulfate octadecahydrate (Al₂(SO₄)₃·18H₂O), aluminum sulfate heptadecahydrate ([Al(H₂O)₆]₂(SO₄)₃·5H₂O; Al₂(SO₄)₃·17H₂O) (also referred to as alugen), or another aluminum sulfate hydrate), double sulfate salts of aluminum sulfate hydrate having the formula MAl(SO₄)₂·12H₂O, wherein M is monovalent cation such as sodium, potassium, or ammonium (such double sulfate salts being referred to as “alum”), or combinations thereof. The alum may include sodium aluminum sulfate (NaAl(SO₄)₂·12H₂O), aluminum sulfate (KAl(SO₄)₂·12H₂O), ammonium aluminum sulfate (NH₄Al(SO₄)₂·12H₂O), or combinations thereof.

The at least one aluminum source may be present in the geopolymer composition at a weight percent within a range of from about 0.01 weight percent to about 10.0 weight percent BWOB. For example, the at least one aluminum source may be present in the geopolymer composition at a weight percent within a range of from about 0.01 weight percent to about 0.05 weight percent, from about 0.05 weight percent to about 0.10 weight percent, from about 0.10 weight percent to about 0.10 weight percent to about 0.20 weight percent, from about 0.20 weight percent to about 0.40 weight percent, from about 0.40 weight percent to about 0.60 weight percent, from about 0.60 weight percent to about 0.80 weight percent, from about 0.80 weight percent to about 1.0 weight percent, from about 1.0 weight percent to about 2.0 weight percent, from about 2.0 weight percent to about 3.0 weight percent, from about 3.0 weight percent to about 5.0 weight percent, or from about 5.0 weight percent to about 10.0 weight percent BWOB. However, the disclosure is not so limited, and the weight percent of the at least one aluminum source may be present in the geopolymer composition at a different weight percent than that described.

The at least one sulfate source may include at least one sulfate salt. The at least one sulfate salt, when dispersed in the carrier fluid and in the geopolymer slurry, may dissociate and form sulfate anions and counterions of the cation. In some embodiments, the at least one sulfate source includes the same material as the at least one aluminum source. For example, the at least one sulfate source may include aluminum sulfate. In some embodiments, the at least one sulfate source includes sodium sulfate (Na₂(SO₄)), calcium sulfate (Ca(SO₄), magnesium sulfate (MgSO₄), iron(III) sulfate (Fe₂(SO₄)₃), another sulfate, or combinations thereof.

The at least one sulfate source may be present in the geopolymer composition at a weight percent within a range of from about 0.01 weight percent to about 1.0 weight percent BWOB. For example, the at least one sulfate source may be present in the geopolymer composition at a weight percent within a range of from about 0.01 weight percent to about 0.05 weight percent, from about 0.05 weight percent to about 0.10 weight percent, from about 0.10 weight percent to about 0.10 weight percent to about 0.20 weight percent, from about 0.20 weight percent to about 0.40 weight percent, from about 0.40 weight percent to about 0.60 weight percent, from about 0.60 weight percent to about 0.80 weight percent, or from about 0.80 weight percent to about 1.0 weight percent BWOB. However, the disclosure is not so limited, and the weight percent of the at least one sulfate source may be present in the geopolymer composition at a different weight percent than that described.

In some embodiments, the geopolymer composition includes a greater weight percent of the at least one sulfate source than the at least one aluminum source. In other embodiments, the geopolymer composition includes a greater weight percent of the at least one aluminum source than the at least one sulfate source.

In some embodiments, the geopolymer composition includes an amount of the at least one aluminum source and the at least one sulfate source such that the geopolymer slurry formed from the geopolymer composition includes a ratio of sulfate anions to aluminum cations of about 3:2. In other words, in some embodiments, the geopolymer slurry exhibits about 1.5 times as may sulfate ions as aluminum ions.

The geopolymer composition may include at least one coagulant. A coagulant may refer to chemical products that are also referred to as flocculants or water clarifiers. In some embodiments, the geopolymer includes one or more inorganic coagulants, such as one or more of alum, iron sulfate, aluminate, polyaluminum chloride, and combinations thereof may be used. In some embodiments, the at least one coagulant includes an organic coagulant. The organic coagulant may include a polyamine (e.g., an alkyl polyamine), or a cationic organic coagulant. The organic coagulant may be an amine-based organic coagulant. The organic coagulant may include one or more of polydiallyldimethylammonium chloride (poly-DADMAC) (e.g., (C₈H₁₆NCl)ₙ, wherein n is an integer representing the degree of polymerization), an epichlorohydrin dimethyl amine copolymer (a DMA-EPI copolymer), a tannin-based organic coagulant, another organic coagulant, or combinations thereof. The organic coagulant may include polyelectrolytes, such as polymers, copolymers, and terpolymers of polyacrylamide with acrylic acid, 2-acrylamido-2-methylpropane sulfonic acid (AMPS), or both.

The coagulant may constitute from about 0.01 weight percent to about 1.00 weight percent BWOB of the geopolymer composition. For example, the coagulant may be present in the geopolymer composition at a weight percent within a range of from about 0.01 weight percent to about 0.05 weight percent, from about 0.05 weight percent to about 0.10 weight percent, from about 0.10 weight percent to about 0.10 weight percent to about 0.20 weight percent, from about 0.20 weight percent to about 0.40 weight percent, from about 0.40 weight percent to about 0.60 weight percent, from about 0.60 weight percent to about 0.80 weight percent, from about 0.80 weight percent to about 1.0 weight percent, from about 1.0 weight percent to about 2.0 weight percent, from about 2.0 weight percent to about 3.0 weight percent, from about 3.0 weight percent to about 5.0 weight percent, or from about 5.0 weight percent to about 10.0 weight BWOB. However, the disclosure is not so limited, and the weight percent of the coagulant in the geopolymer composition at a different weight percent than that described.

In some embodiments, the geopolymer composition includes the at least one aluminum source, the at least one sulfate source, and the at least one coagulant. In other embodiments, the geopolymer composition includes the at least one aluminum source and the at least one sulfate source but may not include the at least one coagulant. In further embodiments, the geopolymer composition does not include the at least one aluminum source or the at least one sulfate source and includes the at least one organic coagulant. In yet other embodiments, the geopolymer composition includes one of the at least one aluminum source or the at least one sulfate source, and further includes the at least one coagulant.

As described above, in some embodiments, the geopolymer composition includes at least one activator. The activator may include an alkali activator or an alkali activator precursor. The alkali activator may be an alkali metal hydroxide, an alkaline-earth metal hydroxide, an alkaline earth metal oxide, an alkaline earth metal peroxide, at least one alkali salt, or combinations thereof. Alkali metal hydroxides may include lithium hydroxide, sodium hydroxide, or potassium hydroxide. Alkaline earth metal hydroxides may include calcium hydroxide, magnesium hydroxide, strontium hydroxide, or barium hydroxide. The alkaline earth metal oxides may be calcium oxide (e.g., lime), magnesium oxide, strontium oxide, barium oxide, or combinations thereof. The alkaline earth metal peroxide may be calcium peroxide or magnesium peroxide. The at least one alkali salt may be a metal carbonate (e.g., M₂CO₃, such as sodium carbonate), a metal sulfate (e.g., M₂SO₄), a metal sulfite (e.g., M₂SO₃), a metal phosphate (e.g., M₃PO₄), a metal oxalate (e.g., M₂C₂O₄), a metal silicate (e.g., M₂ₓSi_{y}O_{(2y+x)}, wherein x is 1, 2, or 3, and y is 1 or 2), a metal fluoride (e.g., MF), a metal hexafluoride (e.g., M₂SiF₆), a metal iodate (e.g., MIO₃), a metal molybdate (e.g., M₂MoO₄), wherein M is a metal such as lithium, sodium, potassium, rubidium, and/or cesium in each of the above examples. The alkali activator may be added as a solid, an aqueous mixture, or an encapsulated liquid or solid material. In an encapsulated embodiment, the solid or liquid activator can be trapped in a capsule that will break when subjected to, for example, mechanical stress on the capsule, or coating degradation from temperature, radiation, and/or chemical exposure. The capsule can also naturally degrade if made from a biodegradable or self-destructive material. Furthermore, the alkali activator when in liquid state may be adsorbed into a porous material and may be released after a certain time or due to a predefined event. The alkali activator may be added to the geopolymer slurry at a concentration between about 1 M to 10M or between 3M and 6M.

In some embodiments, the activator raises the pH of a geopolymer slurry formed from the geopolymer composition upon the addition of water such that the aluminosilicates in the geopolymer composition dissolve and begin to react to form the geopolymer.

As described above, the geopolymer composition may include one or more additives. The one or more additives may include one or more of a metal silicate, a retarder, an accelerator, a binder, a density modifier, a viscosifier, a fluid loss agent, an extender, a dispersant, an antifoam agent, a defoamer, silica, an expanding agent, an anti-settling additive, or combinations thereof.

The metal silicate may include an alkali metal silicate, such as sodium silicate, sodium metasilicate (Na₂SiO₃), potassium silicate (e.g., potassium metasilicate (K₂SiO₃)), calcium silicate (Ca₂SiO₄), calcium metasilicate (CaSiO₃), sodium carbonate (Na₂CO₃), or combinations thereof. Silicates of lithium, sodium, potassium, rubidium, cesium, or their combination can be used.

The metal silicate may be present in the geopolymer slurry at a concentration between 0.01 kg/L and 0.2 kg/L, or between 0.05 kg/L and 0.1 kg/L. The SiO₂/Na₂O molar ratio may be less than or equal to 3.2. The SiO₂/K₂O molar ratio may be less than or equal to or less than 3.2. When mixed with the carrier fluid, the metal silicate may be present in the geopolymer composition at a concentration between about 0.1 M and 5M, or between 0.5M and 2M. The metal silicates may be dry blended with the aluminosilicate source. Also, the metal silicate in another embodiment may be encapsulated.

The thickening time of geopolymer slurries formed from the geopolymer compositions described herein may be influenced by adding retarders and accelerators. Several retarders may delay the setting and hardening of geopolymer slurries. Retarders such as ferric sulfate (Fe₂(SO₄)₃), sodium pentaborate decahydrate, borax, boric acid, lignosulphonates, sodium glucoheptonate tartaric acid, citric acid, sucrose, or phosphorus containing compounds such as phosphoric acid, salts thereof, or mixtures thereof can be included in the geopolymer composition in amounts up to about 0.75 parts per hundred by weight of the total geopolymer composition. In some embodiments, the retarder includes ferric sulfate. The retarder in the geopolymer slurry formed from the geopolymer composition may be present in the geopolymer slurry in amounts up to about 1 part per hundred by weight of the total geopolymer slurry. The amount of retardation of the polymerization reaction, and the setting of the geopolymer slurry, may depend on the type of raw materials used for the slurry and the type and relative quantity of retarding reagent used. In some embodiments, the retarder may also act as a coagulant, such as, for instance, when the retarder comprises iron sulfate (e.g., ferric sulfate).

The accelerator may include lithium salts such as, for example, lithium chloride, lithium hydroxide, or a mixture thereof. The accelerator may be present in the geopolymer composition in amounts up to about 0.4 parts per hundred by weight of the geopolymer composition and up to about 0.5 parts per hundred by weight of the total geopolymer slurry. The amount of acceleration of the polymerization reaction, and the setting of the geopolymer slurry, depends on the type of raw materials used for the slurry and the type and relative quantity of accelerating reagent used.

The one or more binders may include one or more of portland cement, kaolin, bauxite, aluminum oxide, a low density cementitious cement clinker blend, fly ash (siliceous fly ash, calcareous fly ash), slag (a by-product of smelting metal ores and including a mixture of metal oxides and silicon dioxide), tricalcium silicate (3CaO·SiO₂; Ca₃SiO₅) (alite), dicalcium silicate (2CaO·SiO₂; Ca₂SiO₄) (belite), tricalcium aluminate (3CaO·Al₂O₃; CasAl₂O₆), calcium aluminoferrite (4CaO·Al₂O₃·Fe₂O₃; Ca₂(Al,Fe)₂O₅) (brownmillerite), silica fume, diatomaceous earth, pumice, biomass ashes, ground granulated blast furnace slag (hereinafter “GGBS”), and one or more pozzolanic additives. The pozzolanic additives may include one or more of fly ash, D-Dust, glass powder pozzolan, zeolite, rice husk ash, micro-slag, and calcinated clay. In some embodiments, the geopolymer composition does not include (e.g., is substantially free of) a binder, such as one or more of the binders described above.

The density modifier may include density increasing particles and density reducing particles. Density reducing particles may be included in the geopolymer composition to achieve lower geopolymer slurry densities for a given amount of water added, or density increasing particles may be added to achieve higher geopolymer slurry densities. The density reducing particles may include surfactant stabilized gas bubbles, such as nitrogen or air gas bubbles in foams, or may include particles having a low specific gravity and having densities lower than 2 g/cm³, or lower than 1.3 g/cm³. Density reducing particles may include hollow glass or ceramic microspheres (cenospheres), plastic particles such as polypropylene beads, rubber particles, uintaite (sold as GILSONITE™), vitrified shale, petroleum coke or coal or combinations thereof. The density reducing particles may be present in the geopolymer slurry at concentrations between about 0.06 kg/L and 0.6 kg/L (20 lb/bbl and 200 lb/bbl). The particle size range of the density reducing particles may be between about 38 μm and 3350 μm (6 mesh and 400 mesh). The density increasing particles typically may have densities exceeding 2 g/cm³, or more than 3 g/cm³. Density increasing particles may include hematite, barite, ilmenite, silica (e.g., crystalline silica sand), crushed granite and also manganese tetroxide commercially available under the trade names of MicroMax™ and MicroMax FF™.

The viscosifier may include a polysaccharide. In some embodiments, the viscosifier includes diutan gum having a molecular weight higher than about 1×10⁶ can be used. The diutan gum may be present in the geopolymer slurry at a concentration between 0.14 g/L and 1.4 g/L (0.05 lb/bbl and 0.5 lb/bbl). Other viscosifiers may include polysaccharide biopolymers such as welan gum, a polyanionic cellulose (PAC), a carboxymethylcellulose (CMC), or combinations thereof present in the geopolymer slurry a concentration between 0.14 g/L and 1.4 g/L (0.05 lb/bbl and 0.5 lb/bbl). The molecular weight of the polysaccharides, which may be biopolymers, may be between 100,000 and 1,000,000.

The fluid loss agent may include a latex material. The latex may be an alkali-swellable latex. The latex may be present in the geopolymer slurry at a concentration between 0.02 L/L and 0.3 L/L (1 gal/bbl and 15 gal/bbl), or between 0.05 L/L and 0.15 L/L. The extender may include sodium metal silicate, perlite, another material, or combinations thereof. The defoamer may include propylene glycol, such as polypropylene glycol.

The dispersant may include a sodium polynaphthalene sulfonate-based material, carboxylic acids including gluconic acid and soluble salts thereof, glucoheptonic acid and soluble salts thereof, tartaric acid and soluble salts thereof, citric acid and soluble salts thereof, glycolic acid and soluble salts thereof, lactic acid and soluble salts thereof, formic acid and soluble salts thereof, acetic acid and soluble salts thereof, proprionic acid and soluble salts thereof, oxalic acid and soluble salts thereof, malonic acid and soluble salts thereof, succinic acid and soluble salts thereof, adipic acid and soluble salts thereof, malic acid and soluble salts thereof, nicotinic acid and soluble salts thereof, benzoic acid and soluble salts thereof, ethylenediamine tetraacetic acid (EDTA) and soluble salts thereof, phosphoric acid, or combinations thereof.

The expanding agent may include calcium sulfate hemihydrate, metal oxides such as MgO or combinations thereof. The expanding agents may be present in the geopolymer slurry at concentrations between 0.01 kg/L and 0.2 kg/L of the geopolymer slurry, or between 0.05 and 0.1 kg/L.

The geopolymer composition may be mixed with a carrier fluid (e.g., water, brine, or another aqueous material) to form a geopolymer slurry including the geopolymer composition and the carrier fluid (e.g., water). The geopolymer slurry may be a pumpable composition. In use and operation, the geopolymer slurry may be pumped into the annular space between one or more sections of casing 202, 204, 206, 208 (FIG. 2) and the earth formation 101 (FIG. 2) and/or between neighboring sections of casing 202, 204, 206, 208. After setting, the geopolymer slurry may form the geopolymer 210.

A weight percent of the carrier fluid (e.g., water) in the geopolymer composition may be within a range of from about 25.0 weight percent to about 35.0 weight percent, such as from about 25.0 weight percent to about 30.0 weight percent, or from about 30.0 weight percent to about 35.0 weight percent. However, the disclosure is not so limited, and the weight percent of water in the geopolymer slurry may be different than those described.

A density of the geopolymer slurry may be within a range of from about 800 kg/m³ (about 6.69 pounds per gallon (lb/gal) (ppg)) to about 2,900 kg/m³ (about 24.2 ppg), such as from about 800 kg/m³ (about 6.69 ppg) to about 1,000 kg/m³ (about 8.35 ppg), from about 1,000 kg/m³ (about 8.35 ppg) to about 1,200 kg/m³ (about 10.0 ppg), from about 1,200 kg/m³ (about 10.0 ppg) to about 1,400 kg/m³ (about 11.7 ppg), from about 1,400 kg/m³ (about 11.7 ppg) to about 1,600 kg/m³ (about 13.4 ppg), from about 1,600 kg/m³ (about 11.7 ppg) to about 1,800 kg/m³ (15.0 ppg), from about 1,800 kg/m³ (about 15.0 ppg) to about 2,000 kg/m³ (about 16.7 ppg), from about 2,000 kg/m³ (about 16.7 ppg) to about 2,300 kg/m³ (about 19.2 ppg), from about 2,300 kg/m³ (about 19.2 ppg) to about 2,600 kg/m³ (about 21.7 ppg), or from about 2,600 kg/m³ (about 21.7 ppg) to about 2,900 kg/m³ (about 24.2 ppg). However, the disclosure is not so limited, and the density of the geopolymer slurry may be different than those described. A viscosity of the geopolymer slurry may be less than about 400 centipoise (hereinafter “cP”), less than about 350 cP, or less than about 300 cP. The density of the geopolymer slurry may be modified by incorporating one or more of the density reducing particles, density increasing particles, or by altering an amount of the aluminosilicate in the geopolymer composition.

A solid volume fraction (SVF) (defined as the volumetric fraction of the geopolymer slurry comprised of solid particles) of the geopolymer slurry may be within a range of from about 25% to about 60%, such as from about 40% to about 55%. The carrier fluid (in which the solid materials of the geopolymer composition are dissolved) may constitute from about 40% to about 75% by volume of the geopolymer slurry and may be referred to as a liquid volume fraction (LVF). However, the disclosure is not so limited, and the SVF of the geopolymer composition may be different than those described.

A pH of the geopolymer slurry may be greater than about 11.0, such greater than about 11.5, greater than about 12.0, greater than about 12.5, or greater than about 13.0. In some embodiments, the pH of the geopolymer slurry may be controlled by the alkali activator (e.g., the pH of the geopolymer slurry may be increased by increasing the amount of the alkali activator). In some embodiments, the at least one aluminum source includes aluminum chlorohydrate and/or poly aluminum chloride and the geopolymer slurry includes at least one base (e.g., the activator) to increase the pH of the geopolymer slurry and neutralize the aluminum chlorohydrate and/or poly aluminum chloride.

After setting, a density of the cement formed from the cement composition may be within a range of from about 800 kg/m³ (about 6.68 ppg) to about 2,500 kg/m³ (about 12.5 ppg), such as from about 800 kg/m³ (about 6.68 ppg) to about 1,500 kg/m³ (about 12.5 ppg), or from about 1,500 kg/m³ (about 12.5 ppg) to about 2,500 kg/m³ (about 20.86 ppg), however the disclosure is not so limited, and the density of the cement may be different than those described.

The geopolymer slurry and the set geopolymer may include precipitates, such as calcium sulfate, calcium carbonate and aluminum oxide. In some embodiments, the geopolymer slurry includes calcium sulfate formed as a precipitate of the sulfate anions and the calcium oxides (e.g., lime) or magnesium oxides present in the geopolymer composition, such as from the at least one activator. The sulfate anions present in the geopolymer slurry may react with the dissolved calcium and/or dissolved magnesium to form calcium sulfate and/or magnesium sulfate, controlling the amount of unhydrated calcium oxides and/or magnesium oxides in the geopolymer slurry (and the resulting geopolymer). The unhydrated calcium oxides and/or unhydrated magnesium oxides may hydrate (e.g., to form calcium hydroxide (Ca(OH)₂) and/or magnesium hydroxide (Mg(OH)₂)), causing the geopolymer to expand. Excessive expansion of the geopolymer may result in microfractures in the geopolymer, increasing the permeability of the geopolymer and the ability of the geopolymer to seal different zones of the earth formation. Accordingly, the geopolymer slurry may include a sufficient amount of calcium oxide and/or magnesium oxide such that the set geopolymer exhibits a desired level of expansion but does not exhibit more than a desired level of expansion causing the geopolymer to fracture. The amount of unreacted calcium oxide in the geopolymer slurry may be within a range of from about 0.1 weight percent to about 5.0 weight percent. In addition, the amount of calcium sulfate in the geopolymer may be from about 0.1 weight percent to about 5.0 weight percent. However, the disclosure is not so limited, and the weight percent of the unreacted calcium oxide in the geopolymer slurry and/or the weight percent of the calcium sulfate in the geopolymer may be different than that described. The amount of unreacted Calcium Oxide may depend on the density of the slurry and the application.

Without being bound by any particular theory, it is believed that the at least one aluminum source facilitates compressive strength development of the geopolymer slurry. For example, it is believed that the aluminum ions (which are formed by dissolution of the at least one aluminum source) in the geopolymer slurry including the at least one activator contribute to the kinetics of geopolymerization of the at least one aluminosilicate source in a different manner than other non-hydroxy-aluminate ions and interact with the aluminum silicate matrix differently than materials present in other geopolymer compositions. It is believed that the aluminum ions react with the dispersed hydroxide ions present in the geopolymer slurry (e.g., from the at least one activator) to form aluminate (Al(OH)₄), which interacts with the aluminum silicate matrix differently than materials present in other geopolymer compositions, enhancing the activation of the geopolymer and increasing the compressive strength development of the geopolymer slurry.

In some embodiments, the faster CSD of the cement slurry facilitates faster operation of wellbore operations after cementing operations utilizing the geopolymer compositions described herein. Accordingly, the geopolymer compositions may improve an efficiency of the cementing operations and improve a profitability of wellbore operations.

In addition, without being bound by any particular theory, it is believed that the presence of one or more of the at least one aluminum source, the at least one sulfate source, or the coagulant facilitates agglomeration of particles in the geopolymer slurry, reducing the viscosity of the geopolymer slurry. It is believed that the presence of highly charged ions, such as aluminum cations (Al³⁺), sulfate anions (SO₄²⁻), and/or the coagulant in the geopolymer slurry facilitate agglomeration of small particles, such as small aluminosilicate particles, microsilica particles, silica fume particles, and/or density increasing or density decreasing particles in the geopolymer composition, reducing their tendency to gel and improving the rheology of the geopolymer slurry. Accordingly, the aluminum cations, the sulfate anions, and/or the coagulant in the geopolymer slurry facilitate improving the flowability of the geopolymer slurry, allowing the geopolymer slurry to overcome static periods during a cementing operation.

In some embodiments, the set geopolymer includes insoluble calcium sulfate. Without being bound by any particular theory, it is believed that the calcium sulfate in the geopolymer increases the ultimate compressive strength and the ductility of the geopolymer compared to geopolymers formed within the at least one aluminum source and/or the at least one sulfate source. It is believed that the presence of domains of calcium sulfate in the geopolymer increases the ultimate compressive strength and the ductility of the geopolymer. In addition, it is believed that the calcium sulfate reduces the permeability of the geopolymer to fluids (e.g., liquids, gases), improving the low permeability of the geopolymer. Further, since the at least one aluminum source, the at least one sulfate source, and/or the at least one coagulant facilitates agglomeration of relatively small particles in the geopolymer slurry and the resulting set geopolymer, the fluid loss of the geopolymer may be reduced compared to geopolymers formed from geopolymer compositions not including the one or more of the at least one aluminum source, the at least one sulfate source, or the at least one coagulant. In some embodiments, the agglomeration of the particles facilitates controlling a particles size distribution of solid particles in the geopolymer slurry. In some embodiments, the geopolymer includes nanosized calcium sulfate, such as calcium sulfate having a size within a range of from about 50 nm to about 1,000 nm, such as from about 50 nm to about 100 nm, from about 100 nm to about 300 nm, from about 300 nm to about 500 nm, or from about 500 nm to about 1,000 nm. However, the disclosure is not so limited, and the size of the calcium sulfate in the geopolymer may be different than that described.

In some embodiments, the geopolymer includes precipitated alumina. For example, due to the high pH of the geopolymer slurry, at least a portion of the dispersed aluminum cations in the geopolymer slurry precipitate as alumina. In some embodiments, the alumina is precipitated in the geopolymer slurry in-situ. The alumina may be nanosized having a particle size within a range of from about 50 nm to about 1,000 nm, such as from about 50 nm to about 100 nm, from about 100 nm to about 300 nm, from about 300 nm to about 500 nm, or from about 500 nm to about 1,000 nm.

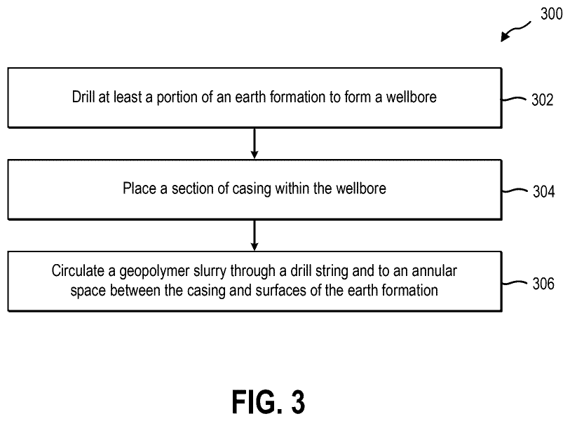

FIG. 3 is a simplified flow chart illustrating a method 300 of performing a cementing operation, according to at least one embodiment of the present disclosure. The method 300 includes drilling at least a portion of an earth formation to form a wellbore, as shown in act 302. A drilling fluid may be circulated through the wellbore during drilling of the earth formation.

The method 300 further includes placing a section of casing within the wellbore, as shown in act 304. Responsive to placing the section of casing within the wellbore, the method 300 further includes circulating a geopolymer slurry through a drill string and to an annular space between the casing and the surfaces of the earth formation, as shown in act 306. The geopolymer slurry may include any of the geopolymer slurries formed from any of the geopolymer compositions described above. The geopolymer slurry may be formed from and include at least one of an aluminum salt, a sulfate salt, or an organic coagulant.

Responsive to circulating a geopolymer slurry through a drill string and to an annular space between the casing and the surfaces of the earth formation, the geopolymer slurry may set to form a geopolymer.

### EXAMPLES

### Example 1

Geopolymer slurries formed from a geopolymer composition including aluminosilicate, a sodium metasilicate extender, a lime activator, a polypropylene glycol antifoam agent were prepared. Some of the geopolymer compositions included aluminum sulfate. The geopolymer compositions were mixed with the same weight percent of water to form the geopolymer slurries. The geopolymer slurries included different amounts of the aluminum sulfate. The compressive strength of the geopolymers was measured at about 72.2° C. (about 162° F.). The composition of the geopolymer slurries and the compressive strength of the geopolymers formed therefrom are shown in Table 1 below.

TABLE 1

| | Geopolymer | Geopolymer | Geopolymer | Geopolymer |
|---|---|---|---|---|
| | Composition 1 | Composition 2 | Composition 3 | Composition 4 |
| Density (ppg) | 15.8 | 15.8 | 15.8 | 15.8 |
| Solid volume | 38.05 | 37.41 | 37.41 | 37.41 |
| fraction | | | | |
| Aluminosilicate | 100% BWOB | 100% BWOB | 100% BWOB | 100% BWOB |
| Sodium | 15% BWOB | 15% BWOB | 15% BWOB | 15% BWOB |
| metasilicate | | | | |
| extender | | | | |
| Lime activator | 3% BWOB | 3% BWOB | 3% BWOB | 3% BWOB |
| Polypropylene | 0.02 gps | 0.02 gps | 0.02 gps | 0.02 gps |
| glycol antifoam | | | | |
| agent (gallons | | | | |
| per sack of 1 ft³ | | | | |
| geopolymer | | | | |
| composition) | | | | |
| Aluminum sulfate | 0 | 0.1% BWOB | 0.5% BWOB | 1.0% BWOB |
| Compressive | 116 | 110 | 117 | 193 |
| Strength at | | | | |
| 72.2° C. (psi) | | | | |

As shown in Table 1, the geopolymer compositions including the aluminum sulfate exhibited increasing compressive strength with increasing amounts of the aluminum sulfate. Accordingly, the aluminum sulfate may increase the compressive strength of the geopolymers formed from the geopolymer composition.

The embodiments of geopolymer composition, the geopolymer slurry, and the geopolymer formed therefrom have been primarily described with reference to wellbore cementing operations; the geopolymer composition, the geopolymer slurry, and the geopolymer formed therefrom described herein may be used in applications other than the cementing of a wellbore. In other embodiments, geopolymer composition, the geopolymer slurry, and the geopolymer formed therefrom according to the present disclosure may be used outside a wellbore or other downhole environment used for the exploration or production of natural resources. For instance, geopolymer composition, the geopolymer slurry, and the geopolymer formed therefrom of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

The wellbore may be used for recovery of hydrocarbons from the earth formation. For example, after forming the wellbore and performing cementing operations, the wellbore may be used to recover hydrocarbons from a hydrocarbon reservoir through which the wellbore extends. The wellbore may be used for stimulating the earth formation and the reservoir for enhancing oil recovery.

In some embodiments, the wellbore may be used for carbon capture, utilization, and storage (CCUS) and/or for recovery and use of geothermal energy. Geothermal energy is a promising source of renewable energy that captures energy from heat generated or stored within the earth. For example, geothermal energy may be used to perform climate control (e.g., heating, cooling) for structures (e.g., buildings) using heat pumps and/or to generate electricity (e.g., by heating water to generate steam and drive a turbine with the steam). The wellbores described herein may be used to circulate a working fluid that exchanges heat within the earth formation through which the wellbore extends. The working fluid may be circulated to the surface where a surface heat exchanger is used to transfer thermal energy to another fluid used to generate electricity and/or for climate control. After the thermal energy is transferred from the working fluid in the surface heat exchanger, the working fluid is circulated back to the earth formation to continue the cycle.

CCUS facilitates the capture, use, and/or storage of carbon (e.g., carbon dioxide), which has a goal of achieving carbon neutrality and/or net zero carbon emissions (NZE). Carbon capture may include the capture of carbon dioxide from large point sources, such as power plants, refineries, cement plants, other industrial processing plants, or other industrial facilities that use fossil fuels, biomass fuels, or other fuels that generate carbon dioxide. The captured carbon dioxide may be converted into valuable products such as, for example, ethanol, sustainable aviation fuel, chemicals, mineral aggregates, and/or other products. Alternatively, the carbon dioxide may be stored in geologic formations, such as in depleted hydrocarbon reservoirs. The carbon dioxide may be introduced into the earth formation through a wellbore, such as the wellbores described herein. In the earth formation, the carbon in the carbon dioxide may be dispersed in an aqueous phase and stored as carbon dioxide, may be stored in mineral form (e.g., as a carbonate, such as calcium carbonate, magnesium carbonate, iron(II) carbonate), or as another form of carbon.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A geopolymer composition, comprising:
at least one aluminosilicate source; and
at least one material comprising one or more of an aluminum source, a sulfate source, or an organic coagulant.

2. The geopolymer composition of claim 1, wherein the at least one material includes the aluminum source and the sulfate source.

3. The geopolymer composition of claim 2, wherein the aluminum source and the sulfate source are formed from the same material.

4. The geopolymer composition of claim 1, wherein the at least one material includes aluminum sulfate salt.

5. The geopolymer composition of claim 1, further comprising an alkali activator or an alkali activator precursor.

6. The geopolymer composition of claim 5, wherein the alkali activator or the alkali activator precursor includes one or more of sodium hydroxide, potassium hydroxide, magnesium hydroxide, calcium hydroxide, strontium hydroxide, or barium hydroxide.

7. The geopolymer composition of claim 1, further comprising at least one metal silicate.

8. The geopolymer composition of claim 1, wherein the at least one material includes one or more of aluminum sulfate, millosevichite, at least one aluminum sulfate hydrate, or a double salt of aluminum sulfate hydrate.

9. The geopolymer composition of claim 1, wherein the at least material includes a double sulfate salt of aluminum sulfate hydrate having the formula MAl(SO₄)₂·12H₂O, wherein M comprises sodium, potassium, or ammonium.

10. The geopolymer composition of claim 1, wherein the at least one material includes a hydrate of aluminum sulfate.

11. The geopolymer composition of claim 10, wherein the hydrate of aluminum sulfate includes a hexadecahydrate, an octadecahydrate, or a heptadecahydrate of aluminum sulfate.

12. The geopolymer composition of claim 1, wherein the at least one material includes an aluminum source including at least one of aluminum chlorohydrate, poly aluminum chloride, aluminum trichloride, calcium aluminate, aluminum containing industrial waste, red mud, or aluminum phosphate.

13. The geopolymer composition of claim 1, wherein the at least one material includes the organic coagulant.

14. The geopolymer composition of claim 13, wherein the organic coagulant includes polydiallyldimethylammonium chloride, an epichlorohydrin dimethyl amine copolymer, a tannin-based organic coagulant, or combinations thereof.

15. The geopolymer composition of claim 1, wherein the at least one material includes the aluminum source, the sulfate source, and the organic coagulant.

16. The geopolymer composition of claim 1, further comprising ferric sulfate.

17. The geopolymer composition of claim 1, further comprising one or more additives selected from the group consisting of a metal silicate, a retarder, an accelerator, a binder, density modifier, a viscosifier, a fluid loss agent, an extender, a dispersant, an antifoam agent, a defoamer, silica, an expanding agent, an anti-settling additive, and combinations thereof.

18. The geopolymer composition of claim 1, wherein the at least one aluminosilicate source constitutes from about 90 weight percent to about 99 weight percent of the geopolymer composition.

19. A geopolymer slurry, comprising:
a geopolymer composition including:
at least one aluminosilicate source;
aluminum cations formed from at least one aluminum salt; and
sulfate anions formed from at least one sulfate salt; and
an aqueous carrier fluid.

20. A method of cementing a subterranean borehole, the method comprising:
mixing water with a geopolymer composition to form a geopolymer slurry,
the geopolymer composition comprising:
at least one aluminosilicate source;
at least one of an aluminum salt, a sulfate salt, or an organic coagulant; and
at least one activator; and
pumping the geopolymer slurry into an annular space between a casing and a subterranean formation defining the subterranean borehole.
